(19) United States
(12) Patent Application Publication
(10) Pub. No.: US 2002/0054076 A1
(43) Pub. Date: May 9, 2002

(54) Active browser for reconstructing user interface and screen menu

(76) Inventor: Chang Gon Kim, Seoul (KR)

Correspondence Address: LAHIVE & COCKFIELD, 28 STATE STREET, BOSTON, MA, 02109, US

(21) Appl. No.: 09/733,871

(22) Filed: Dec. 8, 2000

(30) Foreign Application Priority Data
Dec. 11, 1999 (KR) 1999-56882

(51) Int. Cl. G09G 5/00

(52) U.S. Cl. 345/733

(57) ABSTRACT

In the active browser for reconstructing a user interface and a screen menu, a shape and a function of a web browser can be corrected and changed more conveniently, by reconstructing the user interface so that an internet explorer as the web browser is matched with a requirement characteristic of a user, the web browser being for supporting a component object model (COM) to commonly own data and codes in its operation. Herewith, the COM capable of mutually owning in common the data and codes and of operating is compacted then is provided as an active X control as an active browser editor. The active X control receives desired information through a script written in a hypertext markup language (HTML), checks whether or not there is the desired information referring to an active browser data directory and a windows registry, and constructs an address and information of a data server through the script. Meanwhile, desired data as an engine file is downloaded from a server, and is installed in an active browser directory of a user computer to construct information. Then, the active browser is driven, to whereby enable to reconstruct the shape and the function of the web browser according to a requirement characteristic of the user.

### FIELD OF THE INVENTION

The present invention relates to an active browser for reconstructing a shape and a function of a web browser according to a requirement characteristic of a user; and, more particularly, to an active browser for reconstructing a user interface and a screen menu, in which a shape and a function of a web browser can be corrected and changed more conveniently, by reconstructing the user interface so that an internet explorer as the web browser is matched with a requirement characteristic of a user, the web browser being for supporting a component object model (COM) capable of commonly owning data and codes and of operating.

### BACKGROUND OF THE INVENTION

It is difficult in a beginner to sufficiently use the present web browser owing to a uniformed user interface and a complicated construction of a screen menu, despite that its function is prominent. The present web browser further has some insufficient portions to arouse an interest of a user since its shape is simple.

Meanwhile, in a case of an audio visual interleave (AVI) player and an internet explorer of Microsoft Co. in which an extension tag such as a specific table function etc. is provided, a component object model (COM) is supported so as to newly reconstruct and reuse program modules already drawn up, and programs for supporting such COM can be operated by commonly owning data and codes on the basis of constant regulations.

Therefore, it is required to develop a web browser in which the user interface and the screen menu can be reconstructed, so that users using an internet escape from the existing web browser based on the uniformed user interface and the complicated construction of the screen menu, then can execute a screen construction more easily and interestingly, properly to a user characteristic.

### BRIEF SUMMARY OF THE INVENTION

Therefore, it is an object of the present invention to provide an active browser for reconstructing a user interface and a screen menu, in which the construction of a screen menu in an internet explorer as a web browser can be reconstructed according to a requirement characteristic of a user, to be thereby corrected and changed more conveniently, and enable to improve an inconvenience caused in a uniformed interface and a complicated construction of the screen menu, the web browser being for supporting a COM so as to reconstruct and reuse program modules on the basis of constant regulations.

To achieve these and other advantages, and in accordance with the purpose of the present invention, in the active browser for reconstructing a user interface, an active X control receives desired information through a script written in a hypertext markup language, checks whether or not there is the desired information referring to an active browser data directory and a windows registry, and constructs an address and information of a data server through the script, the active X control being as an active browser editor provided by compacting a COM operable by commonly owning data and codes by constant regulations. Meanwhile, desired data as an engine file is downloaded from a server, and is installed in an active browser directory of a user computer to construct information. Then, the active browser is driven, to whereby enable to reconstruct a shape and a function of the web browser according to a requirement characteristic of the user.

In addition, the active browser editor is used in an editor, containing a stand-alone version classified into a stand-alone version by customizing and a stand-alone version by editor, and also containing a client-server version classified into a client-server version by customizing and a client-server version by editor, and they can be respectively generated and provided as preview versions in editor which is used for a function of a preview in the midst of working, wherein the stand-alone version by customizing is automatically executed together with a general web browser in a local environment and the stand-alone version by editor is generated by the editor, and the client-server version by customizing is automatically changed in visiting a web site and the client-server version by editor is generated by the editor.

### BRIEF DESCRIPTION OF THE DRAWINGS

The above and other objects and features of the instant invention will become apparent from the following description of preferred embodiments taken in conjunction with the accompanying drawings, in which:

FIG. 1 is an operational flowchart showing an embodiment principle in accordance with the present invention; and

FIG. 2 depicts a drawing showing two embodiments of an active browser reconstructed in the present invention.

### DESCRIPTION OF THE PREFERRED EMBODIMENT

Reference will now be made in detail to the preferred embodiments of the present invention, examples of which are illustrated in the accompanying drawings.

In accordance with the present invention, it is described in detail as follows, an embodiment principle for an active browser in which a screen menu of a web browser can be conveniently corrected and changed so as to be reconstructed according to a requirement characteristic of a user, referring to the accompanied drawings.

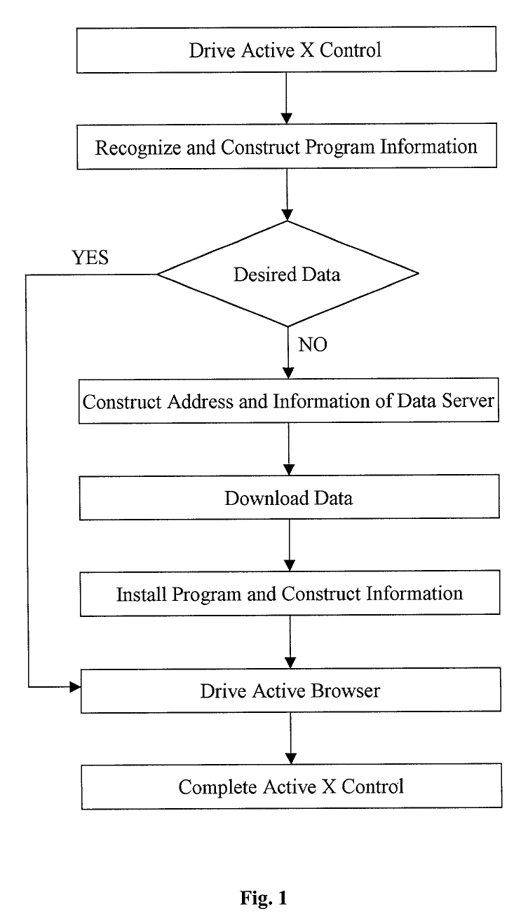

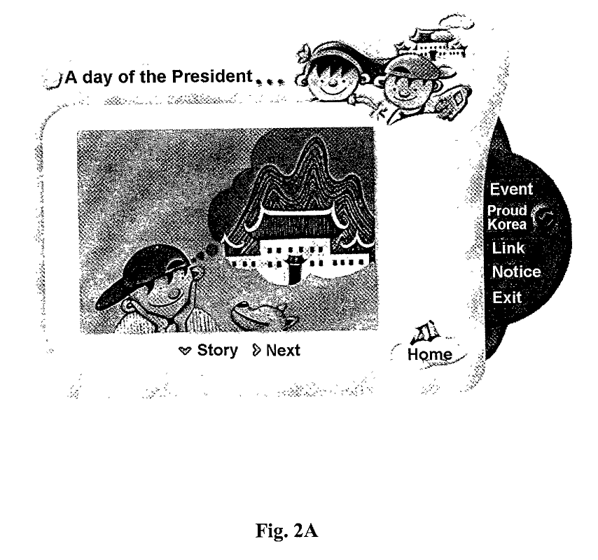

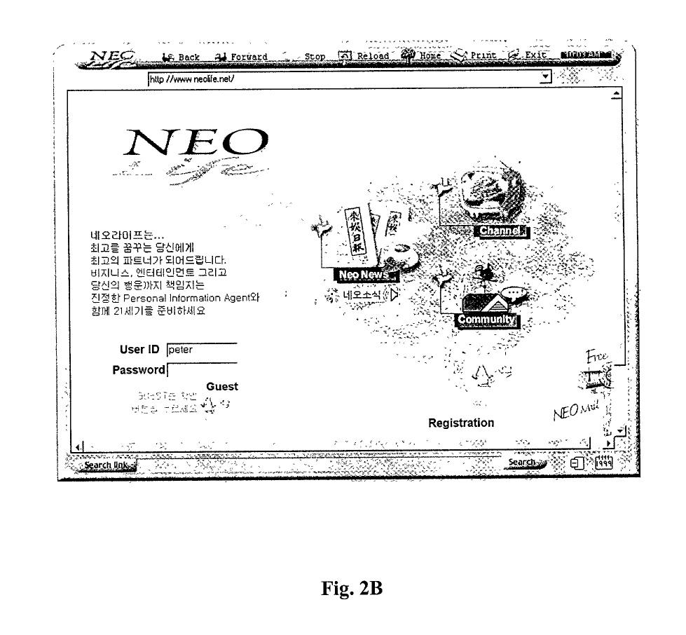

FIG. 1 is an operational flowchart showing an embodiment principle of the present invention, and FIG. 2 represents two embodiments for an active browser reconstructed in the present invention.

As shown in FIG. 1, the inventive active browser is constructed according that an active X control receives desired information from a user through a script written in a hypertext markup language, recognizes corresponding program information and constructs it, meantime, the user has a download for desired data as an engine file from a server, installs it in an active browser directory of a user computer and constructs the information; thereby it can be used as the web browser having a screen menu reconstructed by the requirement characteristic of the user.

Such active browser should receive a download for engine files from the server through a mutual operation with an internet explorer of Microsoft Co., and then should install it, the engine files being necessary for a screen driving matched with the requirement characteristic of the user. An active X control manufactured and used at this time is an active browser editor gained by compacting a component object model (COM) so as to use it more rapidly and conveniently in an internet and to newly reconstruct and reuse program modules by constant regulations.

That is, in the active X control, information necessary for a driving of the active browser is determined through a mutual operation of an HTML and the internet explorer, the HTML being capable of jumping to other file or site by an instruction entered that when any one point of the screen is clicked, and the engine file necessary for the driving of the active browser is downloaded from the server, to install it at a user computer and to perform the driving. Herewith, as use languages, a Visual C++6.0 and an INET SDK (INET Software Development Kit) are used.

Further, in the active browser generated by the active browser editor, it is not supported a resizing function of changing a size of a window in a window system or a size of other figures represented, but it is supported a full-screen mode in which an HTML view area occupies an overall screen.

Herewith, it is constructed with predefined buttons and buttons having functions not predefined, such as direct or execute functions etc., and in a case of adding a function not defined in the editor, a specific customizing work is needed. Furthermore, in a systematic environment for a driving of the active browser, the systematic environment over the Microsoft-Windows95 (MS-Windows95) and over the internet explorer 3.0 is required.

Like this, the active browser for generating the engine files necessary for the driving in the active browser editor corrects and changes a function and a shape by escaping from a uniform shape of the internet explorer as the existing web browser.

In a case of changing the shape in the customizing or modifying of the existing internet explorer, a shape formed by a polygonal shape or a closed curve line not a square shape is supported, and an outer region of the web browser is extracted to be then represented as various shapes by using the Win32 API (Win32 Application Program Interface) supported in the Windows.

However, in case that a picture file used in a main frame of the Windows is not the square shape, its outer part is extracted by using values for three primary colors of a (0,0)th pixel as RGB, namely, Red-Green-Blue, and the picture file supports only a format based on a bit map (BMP) type.

Further, the resizing is not supported by the active browser editor provided as the present instrument for manufacturing the active browser, and in a case of the resizing, a specific customizing work is needed on the basis of the internet explorer of the Microsoft Co., therefore the explorer of the Microsoft Co. must be definitely installed in the user computer.

In a case of changing the function, an application function itself is customized, to thereby enable to add a function difficult to be provided in a general web browser, and upgrade the function or except the function. A resource or a function etc. necessary for the customizing can be contained into a main program and can also exist in a dynamic link library (DLL) as a mathematical function for calling a program or other specific file type.

Meantime, the active browser may be classified into five types of a stand-alone version, and a client-server version and a preview version according to its generation method.

First, the stand-alone version is separated into a stand-alone version by customizing which is automatically executed together with the general web browser in a local environment, and a stand-alone version by editor which is generated by the editor. Particularly, in a case of the stand-alone version, the resizing function is not supported and a full-screen function is supported.

Next, the client-server version is separated into a client-server version by customizing which is automatically changed in visiting a web site, and a client-server version by editor which is generated by the editor, and particularly in a case of the client-server version, too, the resizing function is not supported and the full-screen function is supported. In addition, it may be classified as a preview version in editor, which is used for a function of a preview in the midst of working, and is used in the editor separately from the stand-alone version and the client-server version.

As shown in the operational flowchart of FIG. 1 representing the embodiment principle of the inventive active browser, the active X control as the active browser editor at a server side is driven, to thus receive desired information through a script described in the HTML.

The active X control checks whether or not there is the desired information, referring to the active browser data directory and a windows registry, and constructs an address and information of the data server through the script. At this time, the address of the server is recognized through the script.

Moreover, a user receives a download for an engine file from the server in which the address and the information of the data server are constructed appropriately to a requirement characteristic of the user, and the user installs it in the active browser directory of the user computer, and then executes it. According to that, the active browser is executed, and at this time, during receiving the download for the data, it is displayed for the user a moving screen as an animation and guide information. After the driving of the active browser, the active X control is completed.

As afore-mentioned, in accordance with the present invention, in an active browser in which a user interface and a screen menu can be reconstructed, more convenient correction and transform can be obtained by reconstructing the configuration for a screen menu of an internet explorer as a web browser according to a requirement characteristic of a user, the web browser being for supporting a COM so as to newly reconstruct and reuse program modules by constant regulations.

There is accordingly an effect of providing the user with an easy and interesting program and also providing respective web sites with a discriminative service, by reconstructing the user interface so as to be matched with a beginner own requirement characteristic, thus to be distinguished from one another per each web site. Whereby even the beginner can use more conveniently the internet explorer which is difficult to be sufficiently utilized in spite of its prominent function due to the current uniformed user interface and complicated menu construction.

It will be apparent to those skilled in the art that various modifications and variations can be made in the present invention without deviating from the spirit or scope of the invention. Thus, it is intended that the present invention cover the modifications and variations of this invention provided they come within the scope of the appended claims and their equivalents.

What is claimed is:

1. An active browser for reconstructing a user interface and a screen menu, characterized in that a COM, which is capable of mutually owning in common data and codes on the basis of constant regulations and of operating, is compacted then is provided as an active X control as an active browser editor, said active X control receives desired information through a script written in a hypertext markup language (HTML), checks whether or not there is the desired information referring to an active browser data directory and a windows registry, and constructs an address and information of a data server through the script; meanwhile, desired data as an engine file is downloaded from the server, is installed in the active browser directory of a user computer to construct the information, and the active browser is driven, to whereby enable to reconstruct a shape and a function of the web browser according to a requirement characteristic of the user.

2. The active browser of claim 1, wherein said active X control as the active browser editor is used in an editor, containing a stand-alone version classified into a stand-alone version by customizing and a stand-alone version by editor, and also containing a client-server version classified into a client-server version by customizing and a client-server version by editor, and they can be respectively generated and provided as preview versions in editor, said stand-alone version by customizing being automatically executed together with a general web browser in a local environment, said stand-alone version by editor being generated by the editor, said client-server version by customizing being automatically changed in visiting a web site, and said client-server version by editor being generated by the editor.
